(19) United States
(12) Patent Application Publication
(10) Pub. No.: US 2006/0253730 A1
(43) Pub. Date: Nov. 9, 2006

(54) Single-disk redundant array of independent disks (RAID)

(75) Inventor: Mark Steven Manasse, San Francisco, CA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/125,051

(22) Filed: May 9, 2005

(51) Int. Cl. G06F 11/00

(52) U.S. Cl. 714/6

(57) ABSTRACT

The vulnerable interval between the occurrence of a localized or spot failure and the occurrence of a detectable disk failure is reduced by providing redundancy within a single disk. Sectors of the disk may be grouped into independent sets. Error-correcting or erasure-correcting codes may be applied across groups of sectors where the maximum number of failures prior to detectable disk failure is expected to be small. It is desirable to place all sectors in adjacent tracks in different redundancy groups. This provides a lower bound on the number of redundancy groups needed.

### FIELD OF THE INVENTION

The present invention relates generally to the field of storage systems, and more particularly, to redundancy techniques and mechanisms.

### BACKGROUND OF THE INVENTION

In designing large storage systems, it is well-known that drive failures are sufficiently common that redundancy techniques (e.g., RAID-1, RAID-5, etc.) should be employed to reduce the frequency of data loss. What is less well observed is that localized failures, such as spot failures and track loss, occur with frequency similar to, or greater than, that of whole drive failure. Moreover, localized failure may presage whole drive failure, but may also be due to noisy channels while writing, an off-track write, or other transient causes.

Detecting failure of a complete drive is relatively easy. The disk may be randomly probed periodically, and when the disk fails to respond, it may be declared failed. Without significant impact on the read and write performance of the drive, the time to detect such a failure can be limited to a few seconds, thereby allowing the repair of a failed disk to begin promptly, and limiting the interval during which the redundancy level is below normal.

Detecting spot failure, which may include track loss, is considerably more difficult than detecting failure of a complete drive. If the failure is completely localized to a single sector, the only way to detect it is to attempt to read that particular sector. Reading a disk start to finish takes many hours, given current disk capacities and bandwidths. Limiting the probing bandwidth to one percent of total capacity, for example, means that the expected time to locate a spot failure is on the order of 1 to 2 weeks. In a conventional RAID-1 or RAID-5 configuration, failure of a corresponding disk during that interval results in data loss. The fraction of a disk lost is small, but in a setting where any data loss is intolerable, such loss is still undesirable.

In view of the foregoing, there is a need for systems and methods that overcome such deficiencies.

### SUMMARY OF THE INVENTION

The following summary provides an overview of various aspects of the invention. It is not intended to provide an exhaustive description of all of the important aspects of the invention, or to define the scope of the invention. Rather, this summary is intended to serve as an introduction to the detailed description and figures that follow.

Embodiments of the invention are directed to systems and methods to reduce the vulnerable interval between the occurrence of a localized or spot failure and the occurrence of a detectable disk failure by providing redundancy within a single disk. Sectors of the disk may be grouped into independent sets. Error-correcting or erasure-correcting codes may be applied across groups of sectors where the maximum number of failures prior to detectable disk failure is expected to be small. It is desirable to place all sectors in adjacent tracks in different redundancy groups. This provides a lower bound on the number of redundancy groups needed.

According to aspects of the invention, by using non-volatile memory to store the redundancy blocks, the impact on drive performance is reduced.

According to further aspects of the invention, every write to a sector becomes a swap: the old value is read while the new value is written.

Additional features and advantages of the invention will be made apparent from the following detailed description of illustrative embodiments that proceeds with reference to the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a flow diagram of an exemplary erasure correction method in accordance with the present invention;

FIG. 2 is a block diagram of a system in which aspects of the invention may be implemented; and

FIG. 3 is a block diagram showing an exemplary computing environment in which aspects of the invention may be implemented.

### DETAILED DESCRIPTION OF ILLUSTRATIVE EMBODIMENTS

The subject matter is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described.

It is desirable that when a spot failure exists, it is discovered quickly. However, because disks are large, it could take hours, days, or even weeks to search an entire disk for spot failures. Undetected spot failures contribute significantly to data loss. The invention is directed to providing redundancy in a single disk, and thus improves a single disk to be a much more reliable object.

Typically, RAID uses a collection of disks of the same type to provide data protection, spreading data across the disks in such a way as to maximize the recoverability of the data if there is a single disk failure. In accordance with the present invention, RAID or another technique, uses a single disk to provide data protection to the single disk.

RAID stands for Redundant Array of Independent Disks. Several different forms of RAID implementation have been defined. Each form is usually referred to as a “RAID level.” Techniques that may be used with the present invention include Raid Level 1 (RAID-1) and Raid Level 5 (RAID-5). RAID-1 is disk mirroring. Data is written to multiple disks simultaneously. Drives are paired and mirrored. All data is 100 percent duplicated on a drive of equivalent size. This provides complete redundancy, but the trade-off is the loss of disk space for the complete second copy. Disks are growing large enough that keeping multiple copies of data on a single disk may be practical, but the cost of disk head seeking may be prohibitive. RAID-5 stripes sectors of data across the multiple drives with the parity interleaved. For data redundancy, drives are encoded with rotated XOR redundancy.

Various protection techniques may be implemented in accordance with the present invention. Techniques that may be used to protect the data on the disk from localized failures include RAID-1 (mirroring), RAID-5 (parity), and erasure codes using multiple checksum values.

The vulnerable interval between the occurrence of a localized or spot failure and the occurrence of a detectable disk failure is reduced by providing redundancy. Redundancy mechanisms are implemented within a single disk subsystem, so that spot failures can be effectively masked. By using non-volatile memory to store the redundancy blocks, the impact on drive performance is reduced.

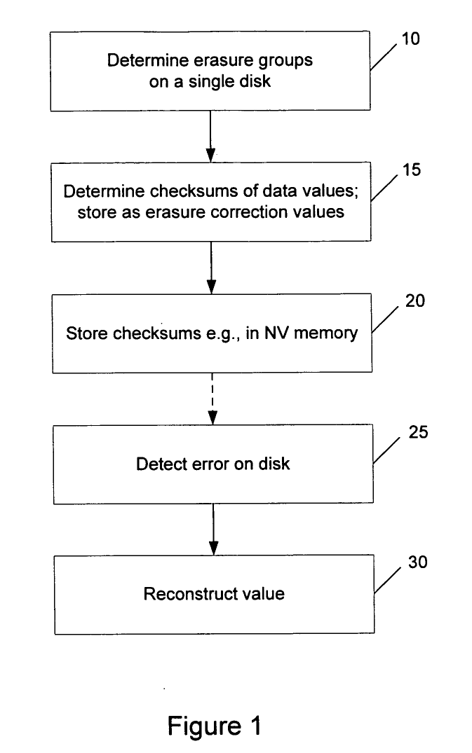

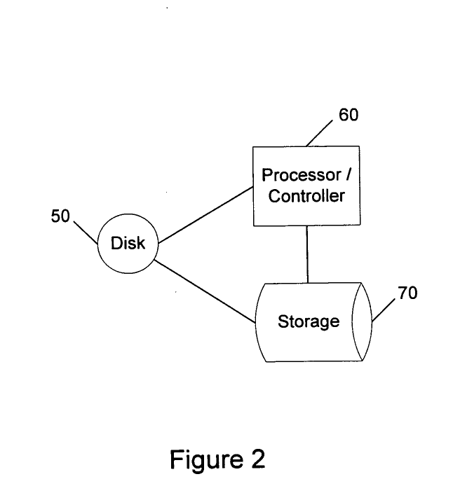

FIG. 1 is a flow diagram of an exemplary erasure correction method in accordance with the present invention, and FIG. 2 is a block diagram of a system in which aspects of the invention may be implemented.

At step 10, erasure groups (also referred to as “redundancy groups”) on a single disk 50 are determined. The disk 50 is read (pursuant to instructions from a processor/controller 60) such that sectors are grouped into independent sets. In the prior art, sectors are chosen on different disks. In accordance with the present invention, sectors are selected on a single disk 50 to detect/account for spot failures.

Desirably, one sector in each non-adjacent track is placed into an erasure group. These sectors are desirably far enough apart that they will have independent failures. Given that a misaligned head can destroy at least a couple of tracks entirely with a single write, it is desirable to place all sectors in adjacent tracks in different erasure groups. This gives a lower bound on the number of erasure groups needed.

At step 15, the checksums of the data values are determined and stored as erasure correction values. These erasure correction values may be applied across erasure groups where the maximum number of failures prior to detectable disk failure is expected to be small. Thus, appropriate checkblocks/parity blocks may be computed such that the number of such blocks is sufficient to survive an anticipated maximum number of concurrent failures.

The checksums are maintained in storage 70, preferably not residing on the disk 50, and more preferably, nonvolatile (stable or battery-backed, for instance) memory, at step 20, as the data values are updated. Conventional techniques, such as logging, multi-phase commit, or other consensus techniques, may be used to guarantee that data gets written in a standard or desired order. The use of nonvolatile memory greatly improves the performance of the system. The nonvolatile memory is desirably used for the buffering of values, so nothing has to be written to disk other than the data itself. Although desirable, the non-volatility is not necessary. For example, some space could be reserved on the platter to hold the redundant encoding, at the cost of multiple disk writes per write (and some seeks). By buffering this in memory, the number of seeks may be reduced. Moreover, the amount of writing may be reduced, e.g., in the case where multiple sectors get written in a group prior to the redundancy code being committed to disk.

At some point, at step 25, an error is detected on a disk. The value may then be reconstructed using the erasure correction value and other data values in the erasure group, at step 30. This computation uses the standard erasure correction technique corresponding to the encoding computed at step 15. For example, if RAID-5 parity encoding is used, all members of the erasure group other than the failed value are read, the exclusive or of those values and the check value is computed, and the result is the reconstruction of the missing value. For encodings providing a higher degree of redundancy, such as a Reed-Solomon code, all the surviving values of data and check blocks in the erasure group are read, suitable arithmetic transformations are performed on each block, and an exclusive or computed. Again, this is the same computation that would have taken place had the values been stored conventionally on distinct disk drives.

Thus, in accordance with the present invention, tracks on a disk are treated as if they were independent disks. Data protection techniques, such as RAID, are then applied to a single disk.

It is contemplated that it may be desirable to work at a level corresponding to file system blocks, rather than individual sectors. For example, if a track contains 10 megabytes, then it contains roughly 4000 sectors, so the number of redundancy groups would have to be roughly 8000. Correspondingly, if RAID-5-like single redundancy (XOR of all sectors in a group) is being used, about 20 megabytes of non-volatile storage would be needed.

In accordance with the present invention, if an efficient linear erasure code, such as a Reed-Solomon code, were to be used, every write to a sector becomes a swap: the old value is read while the new value is being written, and the difference between old and new values is used in step 15 to compute updates to the previous checksum values. In the case when a write requires a seek, the time penalty for this is small: a write requires that the disk head be better-settled than a read, to avoid overwriting adjacent data, so there is a high likelihood that the sector can be read the first time it passes under the heads, even though it could not be written because the head would still be wobbling. As long as the chosen erasure code is linear in its inputs, the effect of a write on a checksum block can be computed just from the prior value of the block and the difference between the old and new values of the sector. Thus, a read modify write is performed on the checkblock from main memory and written back to the nonvolatile memory.

Given the size of tracks and the expected number of elements per group, it is desirable to have redundancy codes supporting thousands of input sectors per check sector. This allows for XOR-based schemes (like EVEN-ODD, for example) or Reed-Solomon codes over large finite fields. GF(256)-based codes may not be desirable because that would be limited to 255 elements per group. In such a case, gigabytes of non-volatile memory would be needed, which is why it is preferable to have codes supporting larger groups. The size of the group impacts the time to reconstruct sectors in the event of spot failure, but this is an infrequent event (e.g., for a specific disk, once-a-month or once-a-year, for example), and so if it takes minutes to repair a failed sector, it is not so critical.

Thus, for example, a disk drive or RAID controller manufacturer could provide enhanced levels of certainty about the reliability of their product at reduced cost.

Exemplary Computing Environment

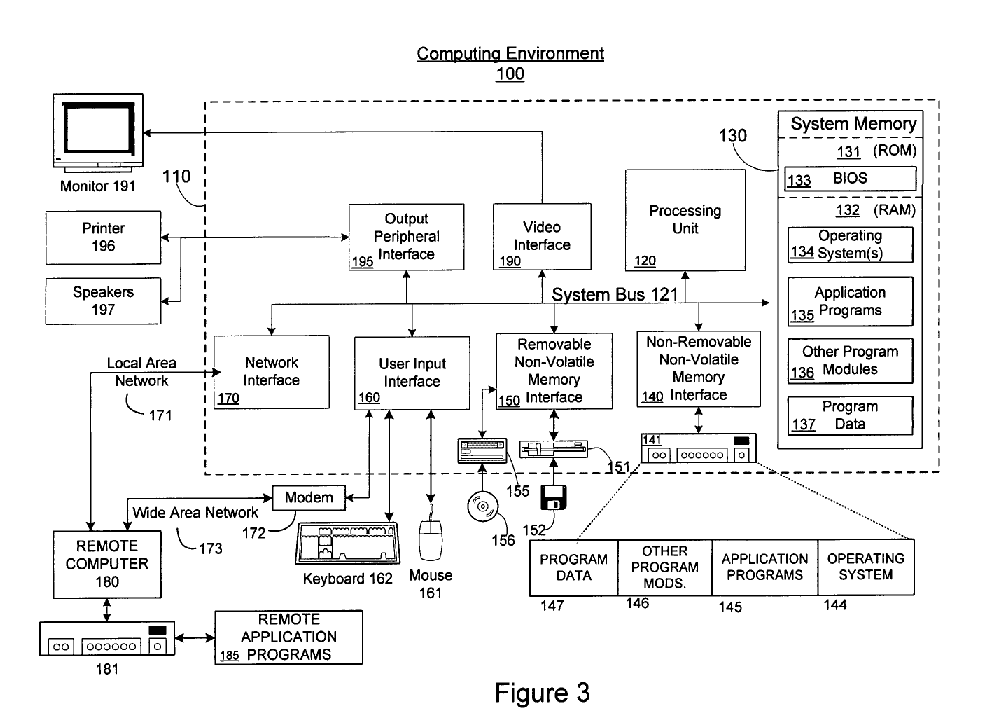

FIG. 3 illustrates an example of a suitable computing system environment 100 in which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 3, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 3 illustrates operating system 134, application programs 135, other program modules 136, and program data 137.

The computer 110 may also include other removable/non-removable, volatile/nonvolatile computer storage media. By way of example only, FIG. 3 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 3, provide storage of computer readable instructions, data structures, program modules and other data for the computer 110. In FIG. 3, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 3. The logical connections depicted include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 3 illustrates remote application programs 185 as residing on memory device 181. It will be appreciated that the network connections shown are exemplary and other means of establishing a communications link between the computers may be used.

The various systems, methods, and techniques described herein may be implemented with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computer will generally include a processor, a storage medium readable by the processor (including volatile and non-volatile memory and/or storage elements), at least one input device, and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the invention. When implemented on a general-purpose processor, the program code combines with the processor to provide a unique apparatus that operates to perform the functionality of the present invention.

While the present invention has been described in connection with the preferred embodiments of the various figures, it is to be understood that other similar embodiments may be used or modifications and additions may be made to the described embodiments for performing the same functions of the present invention without deviating therefrom. Therefore, the present invention should not be limited to any single embodiment, but rather construed in breadth and scope in accordance with the appended claims.

What is claimed:

1. An erasure correction method comprising:
determining a plurality of erasure groups on a single disk, each erasure group comprising a plurality of data values and erasure codes; and
computing checksums of the data values of the erasure groups.

2. The method of claim 1, further comprising storing the checksums in storage as erasure correction values.

3. The method of claim 1, further comprising maintaining the checksums as the data values are updated.

4. The method of claim 3, wherein maintaining the checksums comprises storing the checksums in nonvolatile memory.

5. The method of claim 3, further comprising detecting an error at a location on the disk.

6. The method of claim 5, further comprising correcting the error by reconstructing the value of the location on the disk using an erasure code in the erasure group corresponding to location on the disk.

7. The method of claim 6, wherein correcting the error comprises using an error correction technique corresponding to RAID-5 parity encoding.

8. The method of claim 7, wherein correcting the error comprises reading the values of the erasure group except for the failed value, exclusive or'ing the values, and computing a check value.

9. The method of claim 6, wherein correcting the error comprises using an error correction technique corresponding to Reed-Solomon encoding.

10. A method for reducing redundancy in a storage system, comprising:
grouping a plurality of sectors of a single disk into independent sets; and
applying erasure-correcting codes across the sets of sectors.

11. The method of claim 10, wherein grouping the sectors comprises placing the sectors in adjacent tracks in different ones of the independent sets.

12. The method of claim 10, further comprising reading the disk, and using checksum values to reduce the probability of undetected read errors.

13. The method of claim 10, further comprising storing redundancy blocks of data in non-volatile memory.

14. An erasure correction system comprising:
a processor for determining a plurality of erasure groups on a single disk, each erasure group comprising a plurality of data values and erasure codes, and for computing checksums of the data values of the erasure groups; and
a storage device for storing the checksums in storage as erasure correction values.

15. The system of claim 14, wherein the storage device comprises nonvolatile memory.

16. The system of claim 15, wherein the storage device maintains the checksums as the data values are updated.

17. The system of claim 16, wherein the processor is capable of detecting an error at a location on the disk.

18. The system of claim 17, wherein the processor is adapted to correct the error by reconstructing the value of the location on the disk using an erasure code in the erasure group corresponding to location on the disk.

19. The system of claim 18, wherein correcting the error comprises using an error correction technique corresponding to RAID-5 parity encoding or Reed-Solomon encoding.

20. The system of claim 18, wherein correcting the error comprises reading the values of the erasure group except for the failed value, exclusive or'ing the values, computing a check value, and storing the exclusive or'ed computation as the recovered value.
